(19) United States
(12) Patent Application Publication
(10) Pub. No.: US 2014/0031065 A1
(43) Pub. Date: Jan. 30, 2014

(54) PROVIDING TIME ZONE INFORMATION TO WIRELESS COMMUNICATION DEVICES

(71) Applicant: Apple Inc., Cupertino, CA (US)

(72) Inventors: Marc Schonbrun, San Jose, CA (US); Ronald K. Huang, San Jose, CA (US); Christian W. Mucke, Sunnyvale, CA (US)

(73) Assignee: Apple Inc., Cupertino, CA (US)

(21) Appl. No.: 13/952,516

(22) Filed: Jul. 26, 2013

Related U.S. Application Data
(60) Provisional application No. 61/676,860, filed on Jul. 27, 2012.
(60) Provisional application No. 61/679,663, filed on Aug. 3, 2012.

(51) Int. Cl. H04W 4/02

(52) U.S. Cl. CPC H04W 4/02
USPC 455/456.2; 455/456.1

(57) ABSTRACT

A method for determining current local time for a wireless communication device is provided. The method can include a wireless communication device receiving a message sent by a network entity. The message can include location information indicative of a location associated with a time zone in which a serving cell for the wireless communication device is located. The method can further include the wireless communication device extracting the location information from the message; using the location information to determine the time zone; and determining a current local time based on the time zone.

### CROSS-REFERENCE TO RELATED APPLICATIONS

This application claims priority to U.S. Provisional Patent Application No. 61/676,860, filed on Jul. 27, 2012, and to U.S. Provisional Patent Application No. 61/679,663, filed on Aug. 3, 2012, each of which is incorporated herein in its entirety by reference.

### FIELD OF THE DESCRIBED EMBODIMENTS

The described embodiments relate generally to wireless communications technology, and more particularly to providing time zone information to wireless communication devices to enable such devices to derive a current local time.

### BACKGROUND

Many wireless communication devices implement a clock that may be used to provide time information to time-dependent applications, such as calendar applications. Due to their mobility, wireless communication devices, such as smart phones and tablet computers, are often transported between time zones. When a wireless communication device is transported to another time zone, the device's clock needs to be synchronized to the current local time associated with the time zone so that a valid time may be provided to time-dependent applications. Further, due to seasonal transition between periods in which Daylight Savings Time (DST) is in effect and non-DST periods, wireless communication devices need to resynchronize device clocks to account for the transition in current local time. Time changes due to DST periods can be further complicated due to the fact that government bodies tasked with regulating DST periods frequently modify the start and end dates of DST periods.

Currently, wireless communication devices derive a current local time from timezone information embedded in Network Identity and Timezone (NITZ) signals transmitted by wireless carriers. However, timezone information currently embedded in NITZ signals is limited to a current Coordinated Universal (UTC) time and an offset from UTC time for the wireless communication device's location. Derivation by the wireless communication device of a current time for clock synchronization from the UTC time and offset information Current timezone information in current NITZ signals can be resource intensive, imposing a burden on wireless communication devices. Further, there may be ambiguity in some regions due to different DST rules used by various regions. For example, the State of Arizona in the United States does not implement DST. At certain times of the year, there can be ambiguity as to whether the UTC offset in a NITZ message that can be received by a device in Arizona indicates that a user is located in the America/Phoenix time zone or in the America/Denver time zone. While selecting either time zone can provide an accurate time for a user at least temporarily, errors can result around the time of DST transitions. In this regard, if America/Denver is selected as the time zone for a user located in Arizona, the user's clock can be incorrect when the America/Denver time zone transitions from Mountain Standard Time (MST) to Mountain Daylight Time (MDT). Accordingly, a time derived by a wireless communication device based solely on a current UTC time and offset may not be accurate in instances in which DST is in effect.

### SUMMARY OF THE DESCRIBED EMBODIMENTS

Some embodiments disclosed herein relate to providing time zone information to wireless communication devices to enable such devices to unambiguously derive a current local time. In this regard, some example embodiments can address the problems of ambiguity that can be encountered in regions such as Arizona in which a current UTC and UTC offset can be insufficient to enable a wireless communication device to unambiguously determine a current time zone in which the device is located and to derive a current local time for the time zone. More particularly, a network entity in accordance with some example embodiments can send a message including location information indicative of a location associated with a time zone in which a serving cell for the wireless communication device is located. In some example embodiments, the location information can be a time zone identifier, such as an Internet Assigned Numbers Authority (IANA) time zone (also referred to as an “Olson Time Zone”) identifier, for the time zone in which the serving cell is located. As another example, the location information can be coordinates and/or other location information indicative of a location within the time zone, which can be used by the receiving wireless communication device to determine the time zone in which the serving cell is located. As such, the wireless communication device of such embodiments can use received location information to determine the time zone in which its serving cell is located and thereby derive current local time without susceptibility to the ambiguities inherent in current procedures for deriving current local time based solely on UTC and UTC offset information signaled in NITZ signals. User experience can accordingly be improved, as calendar applications and other applications relying on current local time may not suffer from usage of inaccurate current local time around the time of DST transitions.

In a first embodiment, a method for determining current local time for a wireless communication device is provided. The method can include a wireless communication device receiving a message sent by a network entity. The message can include location information indicative of a location associated with a time zone in which a serving cell for the wireless communication device is located. The location information can, for example, be a time zone identifier, such as an indication of an IANA time zone identifier, for the time zone in which the serving cell is located. The method can further include the wireless communication device extracting the location information from the message; using the location information to determine the time zone; and determining a current local time based on the time zone.

In a second embodiment, a wireless communication device is provided. The wireless communication device of the second embodiment can include a transceiver and processing circuitry coupled to the transceiver. The transceiver can be configured to transmit data to and receive data from a wireless network. The processing circuitry can be configured to control the wireless communication device of the second embodiment to at least receive a message sent by a network entity. The message can include location information indicative of a location associated with a time zone in which a serving cell for the wireless communication device is located. The location information can, for example, be a time zone identifier, such as an indication of an IANA time zone identifier, for the time zone in which the serving cell is located. The processing circuitry can be further configured to control the wireless communication device of the second embodiment to extract the location information from the message; use the location information to determine the time zone; and determine a current local time based at least in part on the time zone.

In a third embodiment, a computer program product is provided. The computer program product of the third embodiment can include at least one non-transitory computer readable storage medium having program code stored thereon. The program code of the third embodiment can include program code for receiving, to a wireless communication device, a message sent by a network entity. The message can include location information indicative of a location associated with a time zone in which a serving cell for the wireless communication device is located. The location information can, for example, be a time zone identifier, such as an indication of an IANA time zone identifier, for the time zone in which the serving cell is located. The program code of the third embodiment can further include program code for extracting the location information from the message; program code for using the location information to determine the time zone; and program code for determining a current local time based on the time zone.

In a fourth embodiment, an apparatus for determining current local time for a wireless communication device is provided. The apparatus of the fourth embodiment can include means for receiving a message sent by a network entity. The message can include location information indicative of a location associated with a time zone in which a serving cell for the wireless communication device is located. The location information can, for example, be a time zone identifier, such as an indication of an IANA time zone identifier, for the time zone in which the serving cell is located. The apparatus of the fourth embodiment can further include means for extracting the location information from the message; means for using the location information to determine the time zone; and means for determining a current local time based on the time zone.

In a fifth embodiment, a method for providing time zone information to a wireless communication device is provided. The method of the fifth embodiment can include a network entity formatting a message including a time zone identifier indicative of a time zone in which a serving cell for the wireless communication device is located; and sending the message to the wireless communication device.

In a sixth embodiment, an apparatus comprising processing circuitry is provided. The apparatus of the sixth embodiment can be implemented on a network entity. The processing circuitry can be configured to control the apparatus of the sixth embodiment to at least format a message including a time zone identifier indicative of a time zone in which a serving cell for the wireless communication device is located; and send the message to a wireless communication device.

In a seventh embodiment, a computer program product for providing time zone information to a wireless communication device is provided. The computer program product of the seventh embodiment can include at least one non-transitory computer readable storage medium having program code stored thereon. The program code of the seventh embodiment can include program code for formatting a message including a time zone identifier indicative of a time zone in which a serving cell for the wireless communication device is located; and program code for sending the message to the wireless communication device.

In an eighth embodiment, an apparatus for providing time zone information to a wireless communication device is provided. The apparatus of the eighth embodiment can include means for formatting a message including a time zone identifier indicative of a time zone in which a serving cell for the wireless communication device is located; and means for sending the message to the wireless communication device.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings are not necessarily drawn to scale, and in no way limit any changes in form and detail that may be made to the described embodiments by one skilled in the art without departing from the spirit and scope of the described embodiments.

FIG. 1 illustrates a wireless communication system in accordance with some example embodiments.

FIG. 2 illustrates a block diagram of an example apparatus that can be implemented on a wireless communication device in accordance with some example embodiments.

FIG. 3 illustrates a block diagram of another example apparatus that can be implemented on a wireless communication device in accordance with some example embodiments.

FIG. 4 illustrates a block diagram of an example apparatus that can be implemented on a network entity in accordance with some example embodiments.

FIG. 5 illustrates a block diagram of another example apparatus that can be implemented on a network entity in accordance with some example embodiments.

FIG. 6 illustrates a flowchart according to an example method for providing time zone information to a wireless communication device in accordance with some example embodiments.

FIG. 7 illustrates a flowchart according to an example method for obtaining time zone information and determining current local time at a wireless communication device in accordance with some example embodiments.

FIG. 8 illustrates a flowchart according to another example method for providing time zone information to a wireless communication device in accordance with some example embodiments.

FIG. 9 illustrates a flowchart according to another example method for obtaining time zone information and determining current local time at a wireless communication device in accordance with some example embodiments.

FIG. 10 illustrates a flowchart according to a further example method for obtaining time zone information and determining current local time at a wireless communication device in accordance with some example embodiments.

FIG. 11 illustrates a flowchart according to an example method for providing time zone information to a wireless communication device in response to a request in accordance with some example embodiments.

FIG. 12 illustrates a flowchart according to an example method for broadcasting time zone information in accordance with some example embodiments.

FIG. 13 illustrates a flowchart according to a further example method for obtaining time zone information and determining current local time at a wireless communication device in accordance with some example embodiments.

### DETAILED DESCRIPTION OF SELECTED EMBODIMENTS

Some example embodiments disclosed herein relate to providing time zone information to wireless communication devices to enable such devices to unambiguously derive a current local time. In this regard, some example embodiments can address situations, such as in the case of Arizona, in which a current UTC and UTC offset can be insufficient to enable a wireless communication device to unambiguously determine a current time zone in which the device is located and to derive a current local time for the time zone. More particularly, a network entity in accordance with some example embodiments can send a message including location information indicative of a location associated with a time zone in which a serving cell for the wireless communication device is located. In some example embodiments, the location information can be a time zone identifier, such as an Internet Assigned Numbers Authority (IANA) time zone identifier, for the time zone in which the serving cell is located. As another example, the location information can be coordinates and/or other location information indicative of a location within the time zone, which can be used by the receiving wireless communication device to determine the time zone in which the serving cell is located.

A wireless communication device in accordance with some such example embodiments can use such location information that can be provided by a network entity to determine the time zone in which its serving cell is located and thereby derive current local time without susceptibility to the ambiguities inherent in prior procedures for deriving current local time based solely on UTC and UTC offset information signaled in NITZ signals. User experience can accordingly be improved, as calendar applications and other applications relying on current local time may not suffer from usage of inaccurate current local time around the time of DST transitions.

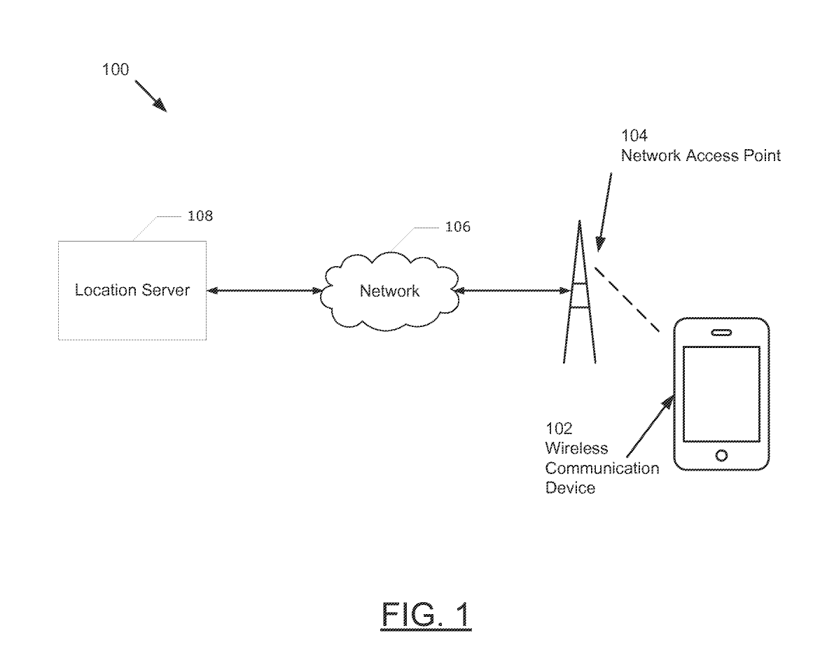

FIG. 1 illustrates wireless communication system 100 in accordance with some example embodiments. The wireless communication system 100 can include a wireless communication device 102 and network access point 104. The wireless communication device 102 can comprise any mobile device configured to operate on a wireless network, such as can be accessed via a network access point 104 or other suitable wireless network access point. By way of non-limiting example, the wireless communication device 102 can be embodied as a cellular phone, such as a smart phone device, a tablet computing device, a laptop computing device, and/or other computing device that can be configured to operate over a wireless network. The network access point

The network access point 104 can be embodied as any entity that can exchange wireless signals with a wireless communication device 102 to provide the wireless communication device 102 with access to a wireless network, such as a cellular network, wireless local area network (WLAN), and/or other type of wireless network. In embodiments in which the network access point 104 is configured to provide access to a cellular network, the network access point 104 can be associated with a serving cell for the wireless communication device 102. In this regard, the network access point 104 of some embodiments can be embodied as any of a variety of cellular base stations, such as by way of non-limiting example, a base transceiver station, node B, evolved node B (eNB), some combination thereof, or the like. In embodiments, in which the network access point 104 is configured to provide access to a cellular network, the network access point 104 and wireless communication device 102 can each be configured to support communication by any present or future developed cellular radio access technology (RAT), such as, by way of non-limiting example, one or more of Long Term Evolution (LTE), LTE-Advanced (LTE-A), Universal Mobile Telecommunication System (UMTS), Code Division Multiple Access 2000 (CDMA2000), Time Division Synchronous Code Division Multiple Access (TD-SCDMA), Wideband Code Division Multiple Access (WCDMA), Global System for Mobile Communications (GSM), and/or other present or future developed cellular RAT.

It will be appreciated, however, that embodiments described with respect to use within cellular networks are provided by way of example, and not by way of limitation. As such, it will be appreciated that such techniques described in connection with those embodiments can be implemented mutatis mutandis to provide time zone information enabling determination of a current local time to wireless communication devices operating on WLANs and/or other types of wireless networks within the scope of the disclosure.

In some example embodiments, the wireless communication system 100 can further include a network 106. The network 106 can comprise any network that can be accessed via a network access point 104 or other network access point. In this regard, by way of non-limiting example, the network 106 can comprise a portion of a cellular network, the Internet, and/or other network.

In some example embodiments, the wireless communication system 100 can further include a location server 108. In embodiments including the location server 108, communication between the wireless communication device 102 and location server 108 can be facilitated by the network 106. In embodiments including a location server 108, the location server 108 can comprise one or more computing devices configured to receive a request message requesting a time zone identifier for a time zone in which a serving cell for a wireless communication device, such as wireless communication device 102, is located and to respond to the request message with a response message including the time zone identifier in accordance with various example embodiments, as will be further described herein below. In this regard, the location server 108 can comprise an entity configured to support a wireless communication device-initiated procedure for obtaining time zone information in accordance with some example embodiments. By way of non-limiting example, in some embodiments, the location server 108 can comprise a Secure User Plane Location (SUPL) server. As still a further example, in some embodiments, the location server 108 can comprise a server maintained by a carrier network, such as may be operated by a cellular services carrier. In some embodiments, the location server 108 can be omitted from the system 100, however.

As will be described further herein below, a network entity in the system 100, such as the network access point 104, location server 108, and/or other network entity that can be implemented in the system 100 can be configured to provide time zone information to the wireless communication device 102, which can be used by the wireless communication device 102 to determine its present time zone and to derive the current local time.

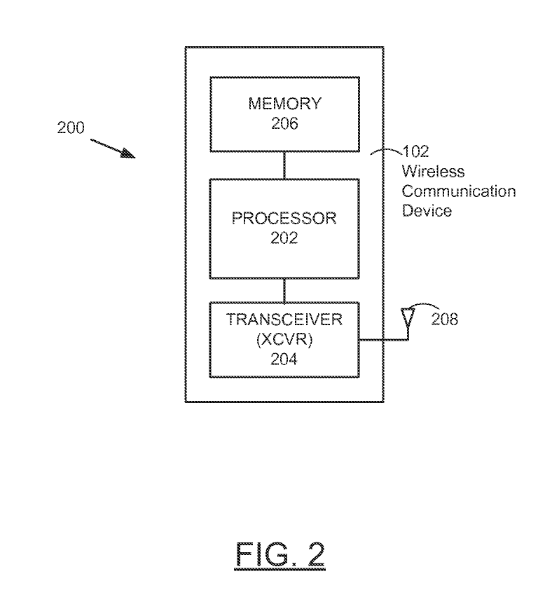

FIG. 2 illustrates a block diagram of an example apparatus 200 that can be implemented on a wireless communication device 102 in accordance with some example embodiments. Apparatus 200 can include a processor 202 coupled to memory 206 and also coupled to a wireless transceiver 204. Processor 202 can be configured to read, write and execute processor instructions stored in memory 206. Processor 202 can also be configured to control wireless transceiver 204. In some embodiments, wireless transceiver 204 can connect to wireless networks, via an access point, such as the network access point 104 (e.g., via antenna 208). Accordingly, in some such example embodiments, the wireless transceiver 204 can be configured to enable receipt of a message including location information, such as a time zone identifier, in accordance with various example embodiments described further herein below. Further, in some such example embodiments, the processor 202 can be configured to control one or more operations that can be performed by a wireless communication device 102 in accordance with various example embodiments. For example, the processor 202 can be configured to control the sending and receipt of messages and determination of current local time by the wireless communication device 102 in accordance with various example embodiments. As a further example, in some such example embodiments, the processor 202 can be configured to extract location information and/or other time zone information from a received message and process the received time zone information to determine current local time.

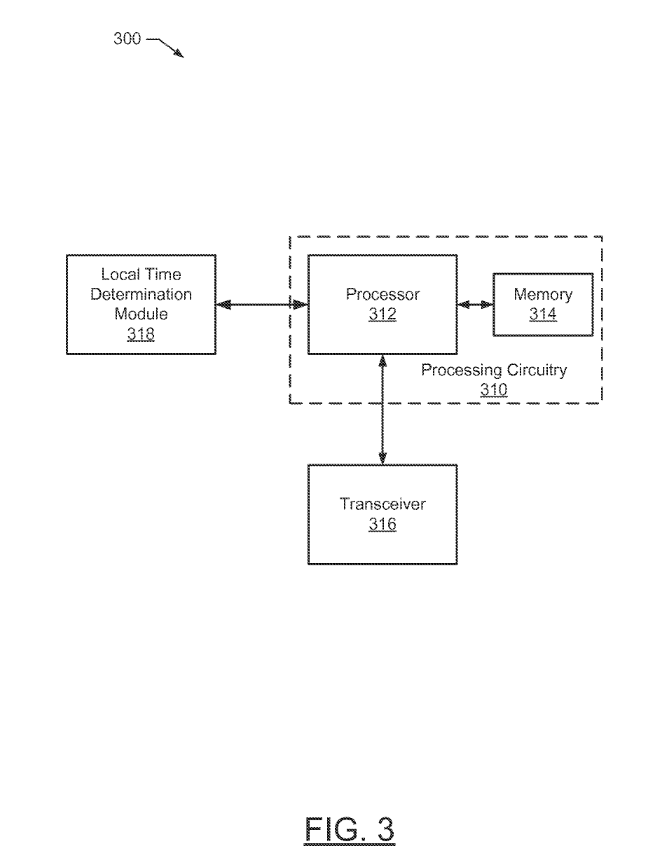

FIG. 3 illustrates a block diagram of another example apparatus that can be implemented on a wireless communication device 102 in accordance with some example embodiments. In this regard, FIG. 3 illustrates an apparatus 300 that can, when implemented on a computing device, such as wireless communication device 102, enable the computing device to operate within the system 100 in accordance with one or more example embodiments. It will be appreciated that the components, devices or elements illustrated in and described with respect to FIG. 3 below may not be mandatory and thus some may be omitted in certain embodiments. Additionally, some embodiments can include further or different components, devices or elements beyond those illustrated in and described with respect to FIG. 3.

In some example embodiments, the apparatus 300 can include processing circuitry 310 that is configurable to perform actions in accordance with one or more example embodiments disclosed herein. In this regard, the processing circuitry 310 can be configured to perform and/or control performance of one or more functionalities of the apparatus 300 in accordance with various example embodiments, and thus can provide means for performing functionalities of the apparatus 300, including one or more functionalities of wireless communication device 102, in accordance with various example embodiments. The processing circuitry 310 can be configured to perform data processing, application execution and/or other processing and management services according to one or more example embodiments.

In some embodiments, the apparatus 300 or a portion(s) or component(s) thereof, such as the processing circuitry 310, can include one or more chipsets, which can each include one or more chips. The processing circuitry 310 and/or one or more further components of the apparatus 300 can therefore, in some instances, be configured to implement an embodiment on a single chip or chipset. In some example embodiments in which one or more components of the apparatus 300 are embodied as a chipset, the chipset can be capable of enabling a computing device to operate in the system 100 when implemented on or otherwise operably coupled to the computing device. Thus, for example, one or more components of the apparatus 300 can provide a chipset configured to enable a computing device to connect to and operate over a wireless network via a connection to a wireless network access point, such as the network access point 104. In accordance with some example embodiments, one or more components of the apparatus 300 can provide a cellular baseband chipset.

In some example embodiments, the processing circuitry 310 can include a processor 312 and, in some embodiments, such as that illustrated in FIG. 3, can further include memory 314. The processor 312 can, for example, be an embodiment of the processor 202. The memory 314 can, for example, be an embodiment of the memory 206. As such, in some example embodiments, the processing circuitry 310 can be at least partially embodied by the processor 202 and/or memory 206. The processing circuitry 310 can be in communication with or otherwise control a transceiver 316 and/or local time determination module 318.

The processor 312 can be embodied in a variety of forms. For example, the processor 312 can be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 312 can comprise a plurality of processors. The plurality of processors can be in operative communication with each other and can be collectively configured to perform one or more functionalities of the apparatus 300 as described herein. In some example embodiments, the processor 312 can be configured to execute instructions that can be stored in the memory 314 or that can be otherwise accessible to the processor 312. As such, whether configured by hardware or by a combination of hardware and software, the processor 312 capable of performing operations according to various embodiments while configured accordingly.

In some example embodiments, the memory 314 can include one or more memory devices. Memory 214 can include fixed and/or removable memory devices. In some embodiments, the memory 314 can provide a non-transitory computer-readable storage medium that can store computer program instructions that can be executed by the processor 312. In this regard, the memory 314 can be configured to store information, data, applications, instructions and/or the like for enabling the apparatus 300 to carry out various functions in accordance with one or more example embodiments. In some embodiments, the memory 314 can be in communication with one or more of the processor 312, transceiver 316, or local time determination module 318 via a bus (or buses) for passing information among components of the apparatus 300.

The apparatus 300 can further include a transceiver 316. The transceiver 316 can, for example, be an embodiment of the transceiver 204. The transceiver 316 can be configured to enable the apparatus 300 to send wireless signals to and receive signals from a wireless network via a connection to a wireless network access point, such as the network access point 104. As such, the transceiver 316 can be configured to support any type of RAT that may be implemented by the network access point 104 and/or otherwise supported by the wireless communication device 102.

The apparatus 300 can further include local time determination module 318. The local time determination module 318 can be embodied as various means, such as circuitry, hardware, a computer program product comprising a computer readable medium (for example, the memory 314) storing computer readable program instructions that are executable by a processing device (for example, the processor 312), or some combination thereof. The local time determination module 318 can be configured to extract time zone information, such as a time zone identifier, location information indicative of a location associated with a time zone in which the wireless communication device 102 is being operated, and/or other time zone information, from a message that can be received by the wireless communication device 102 and can use the extracted time zone information to determine the time zone and derive a current local time based at least in part on the time zone in accordance with one or more example embodiments disclosed herein.

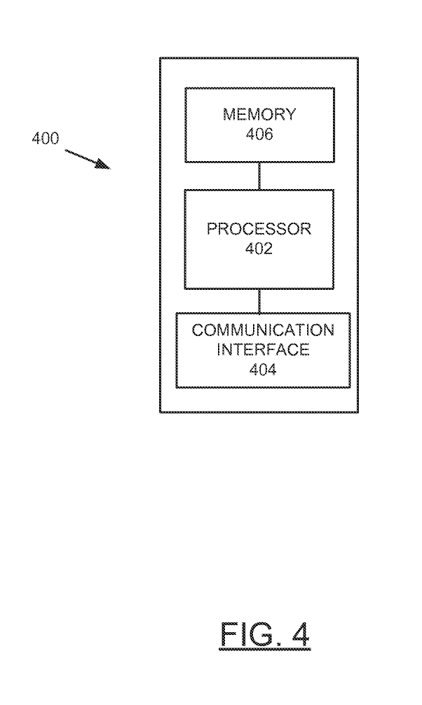

FIG. 4 illustrates a block diagram of an example apparatus 400 that can be implemented on a network entity, such as network access point 104 and/or location server 108, in accordance with some example embodiments. Apparatus 400 can include a processor 402 coupled to memory 406 and also coupled to a communication interface 404. Processor 402 can be configured to read, write and execute processor instructions stored in memory 406. The processor 402 can be further configured to control the communication interface 404. The communication interface 404 can comprise one or more interfaces for enabling communication between entities of the system 100. For example, in embodiments in which the apparatus 400 is implemented on the network access point 104, the communication interface 404 can be configured to enable over-the-air communication with the wireless communication device 102. As another example, in embodiments in which the apparatus 400 is implemented on the location server 108, the communication interface 404 can be configured to support communications over the network 106 such that messages can be exchanged between the location server 108 and wireless communication device 102. As such, it will be appreciated that the apparatus 400 can comprise an entity configured to control the performance of one or more functions of a network access point 104, location server 108, and/or other network entity that can provide time zone information to a wireless communication device 102 in accordance with various example embodiments.

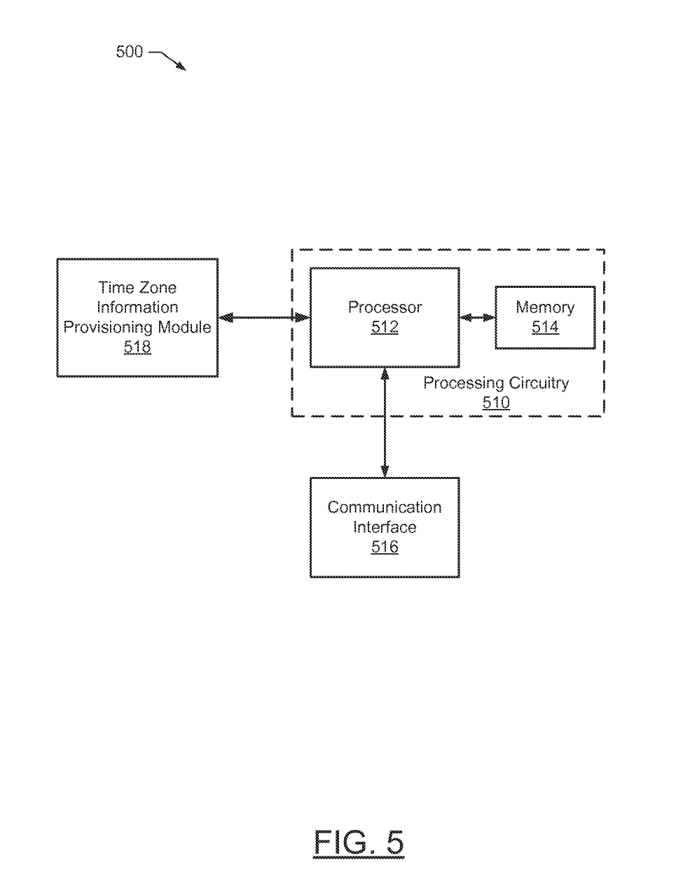

FIG. 5 illustrates a block diagram of another example apparatus that can be implemented on a network entity, such as network access point 104 and/or location server 108, in accordance with some example embodiments. In some example embodiments, one or more components of the apparatus 500 can be distributed across multiple network entities that can be associated with the first network 204, which can be in operative communication with each other. For example, in some embodiments, a component(s) of the apparatus 500 can be implemented on one or more radio access network (RAN) entities (e.g., network access point 104) and/or one or more core network entities of a cellular network. Additionally or alternatively, in some embodiments, a component(s) of the apparatus 500 can be implemented on one or more servers and/or other computing devices, such as location server 108, which can be accessed via network 106. It will be appreciated that the components, devices or elements illustrated in and described with respect to FIG. 5 below may not be mandatory and thus some may be omitted in certain embodiments. Additionally, some embodiments can include further or different components, devices or elements beyond those illustrated in and described with respect to FIG. 5.

In some example embodiments, the apparatus 500 can include processing circuitry 510 that is configurable to perform actions in accordance with one or more example embodiments disclosed herein. In this regard, the processing circuitry 510 can be configured to perform and/or control performance of one or more functionalities of the apparatus 500 in accordance with various example embodiments, and thus can provide means for performing functionalities of a network entity, such as the network access point 104 and/or location server 108, in accordance with various example embodiments. The processing circuitry 510 can be configured to perform data processing, application execution and/or other processing and management services according to one or more example embodiments.

In some example embodiments, the processing circuitry 510 can include a processor 512 and, in some embodiments, such as that illustrated in FIG. 5, can further include memory 514. The processor 512 can, for example, be an embodiment of the processor 402. The memory 514 can, for example, be an embodiment of the memory 406. As such, in some example embodiments, the processing circuitry 510 can be at least partially embodied by the processor 402 and/or memory 406. The processing circuitry 510 can be in communication with or otherwise control a communication interface 516, and/or time zone information provisioning module 518.

The processor 512 can be embodied in a variety of forms. For example, the processor 512 can be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 512 can comprise a plurality of processors. In embodiments including a plurality of processors, the plurality of processors can be implemented on a single entity, or can be distributed across multiple entities that can be in operative communication with each other to perform functions of a network entity in accordance with one or more embodiments. The plurality of processors can be in operative communication with each other and can be collectively configured to perform one or more functionalities of the apparatus 500 as described herein. In some example embodiments, the processor 512 can be configured to execute instructions that can be stored in the memory 514 or that can be otherwise accessible to the processor 512. As such, whether configured by hardware or by a combination of hardware and software, the processor 512 capable of performing operations according to various embodiments while configured accordingly.

In some example embodiments, the memory 514 can include one or more memory devices. Memory 514 can include fixed and/or removable memory devices. In embodiments including multiple memories, the memories can be implemented on a single entity, or can be distributed across multiple entities that can be in operative communication with each other to perform functions of a network entity in accordance with one or more embodiments. In some embodiments, the memory 514 can provide a non-transitory computer-readable storage medium that can store computer program instructions that can be executed by the processor 512. In this regard, the memory 514 can be configured to store information, data, applications, instructions and/or the like for enabling the apparatus 500 to carry out various functions in accordance with one or more example embodiments. In some embodiments, the memory 514 can be in communication with one or more of the processor 512, communication interface 516, or time zone information provisioning module 518 via a bus (or buses) for passing information among components of the apparatus 500.

The apparatus 500 can further include a communication interface 516. The communication interface 516 can, for example, be an embodiment of the communication interface 404. The communication interface 516 can be configured to enable the apparatus 500 to send messages to and receive messages from (e.g., directly and/or via one or more intermediary devices/networks) the wireless communication device 102. In this regard, the communication interface 116 can include one or more interface mechanisms for enabling communication with other devices and/or networks. As such, the communication interface 116 can include, for example, an antenna (or multiple antennas) and supporting hardware and/or software for enabling communications with a wireless communication network (e.g., a cellular network, Wi-Fi, WLAN, and/or the like) and/or a communication modem or other hardware/software for supporting communication via cable, digital subscriber line (DSL), USB, FireWire, Ethernet or other wireline networking methods. As such, the communication interface 516 of some example embodiments can support radio communication with the wireless communication device 102 and/or communication (e.g., wireline and/or wireless communication) over one or more networks, such as network 106.

The apparatus 500 can further include time zone information provisioning module 518. The time zone information provisioning module 518 can be embodied as various means, such as circuitry, hardware, a computer program product comprising a computer readable medium (for example, the memory 514) storing computer readable program instructions that are executable by a processing device (for example, the processor 512), or some combination thereof. In some embodiments, the processor 512 (or the processing circuitry 510) can include, or otherwise control the time zone information provisioning module 518. The time zone information provisioning module 518 of some example embodiments can be configured to format a message including time zone information, such as such as a time zone identifier, location information indicative of a location associated with a time zone in which the wireless communication device 102 is being operated (e.g., a time zone in which a serving cell for the wireless communication device 102 is located), and/or other time zone information, in accordance with one or more example embodiments.

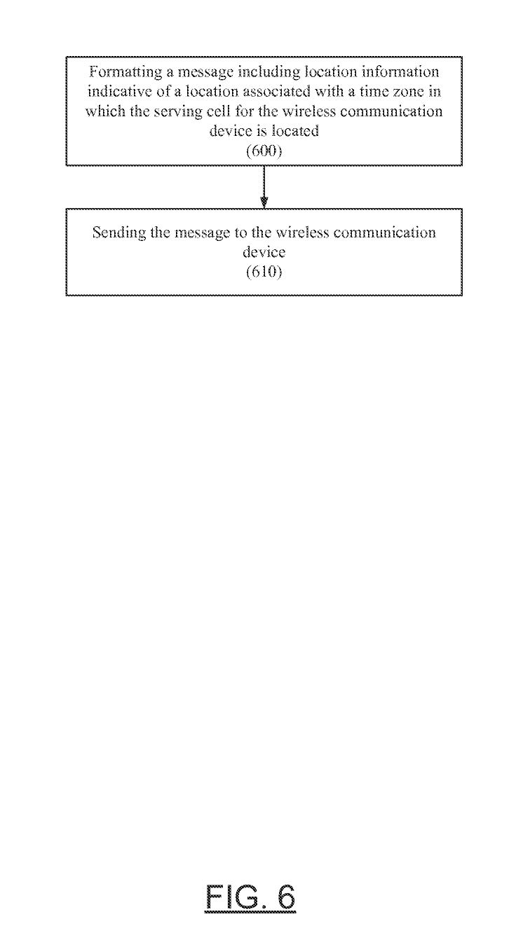

FIG. 6 illustrates a flowchart according to an example method for providing time zone information to a wireless communication device in accordance with some example embodiments. In this regard, FIG. 6 illustrates a method that can be performed by a network entity, such as the network access point 104, location server 108, and/or other network entity in accordance with some example embodiments. One or more of processor 402, communication interface 404, memory 406, processing circuitry 510, processor 512, memory 514, communication interface 516, or time zone information provisioning module 518 can, for example, provide means for performing one or more of the operations illustrated in and described with respect to FIG. 6.

Operation 600 can include a network entity formatting a message including location information indicative of a location associated with a time zone in which the serving cell for the wireless communication device is located. The message can further include an indication of whether DST is in effect in the time zone.

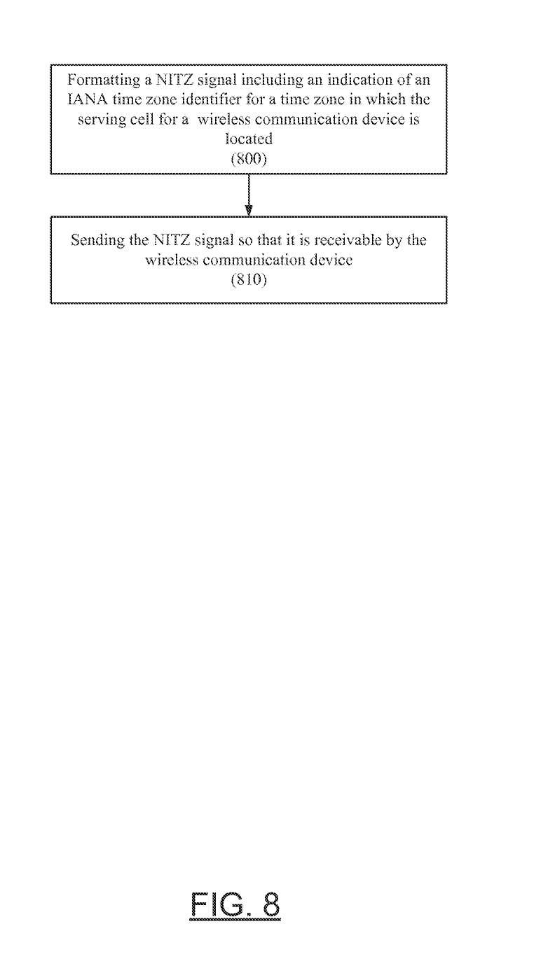

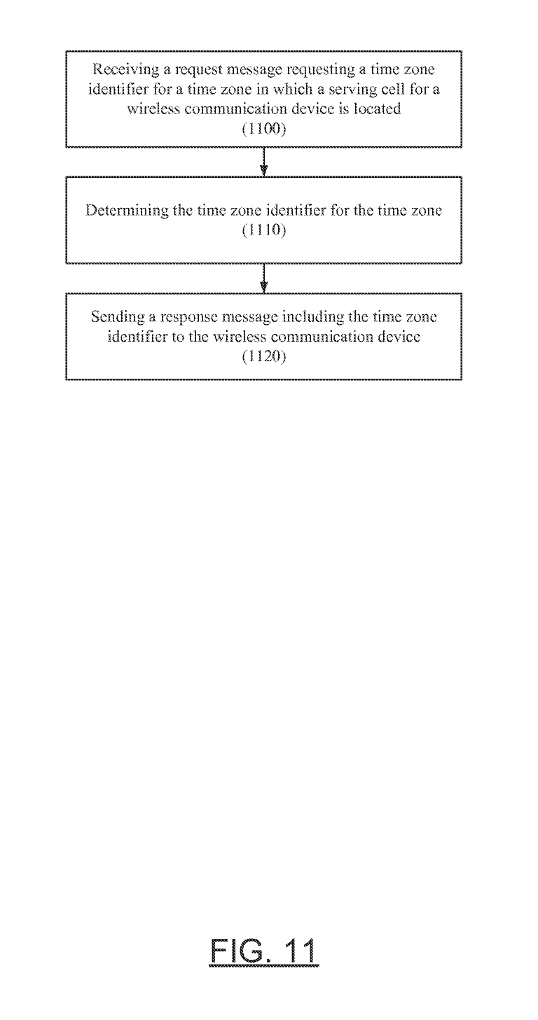

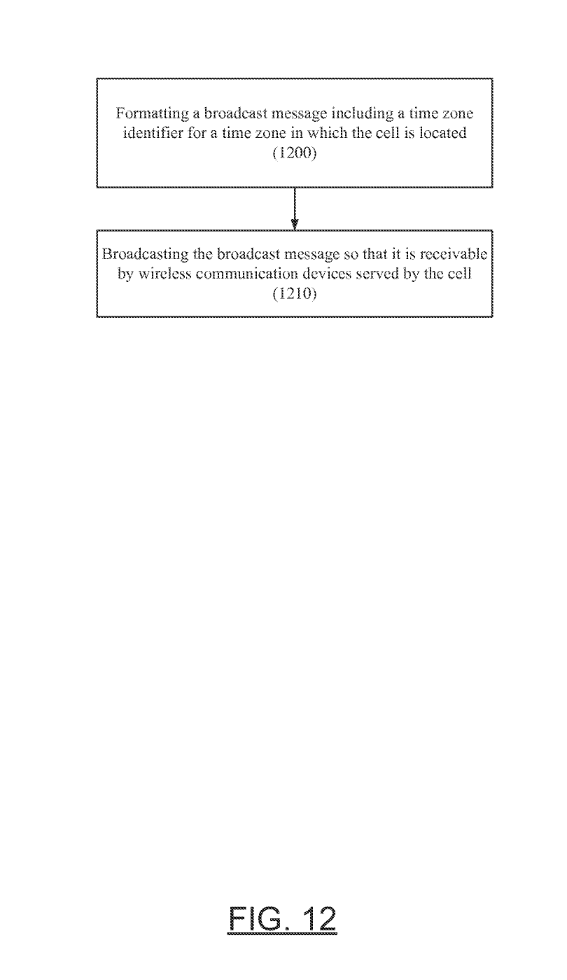

In some example embodiments, such as that illustrated in and described with respect to FIG. 8, the message formatted in operation 600 can be a NITZ signal. As another example, in some example embodiments, such as that illustrated in and described with respect to FIG. 11, the message formatted in operation 600 can be formatted by the location server 108 in response to a request message that can be received from and/or otherwise initiated by the wireless communication device 102 in accordance with some example embodiments. As still a further example, in some example embodiments, such as that illustrated in and described with respect to FIG. 12, the message formatted in operation 600 can be a broadcast message that can be broadcast by the network access point 104 of some example embodiments.

The location information that can be included in the message formatted in operation 600 can include any time zone information that can be indicative of a location within the time zone and/or that can otherwise be used by the wireless communication device 102 to identify the time zone. For example, in some example embodiments, the location information can include a time zone identifier specified for a time zone in accordance with a standardized naming convention for time zones. In this regard, some time zone naming conventions name time zones based at least in part on a location within the time zone. For example, in some example embodiments, the location information can include an Internet Assigned Numbers Authority (IANA) time zone identifier for the time zone, which can be specified in terms of an Area/Location identifier, such as “America/New_York.” It will be appreciated, however, that other time zone naming conventions that presently exist or that may be developed in the future can be used in addition to or in lieu of IANA time zone identifiers in accordance with some example embodiments. In some such example embodiments, an IANA time zone version and/or other indication of whether DST is in effect can also be included in the message. In some example embodiments in which the location information includes a time zone identifier from a standardized database or set of time zone identifiers, such as in embodiments in which IANA time zone identifiers from an IANA time zone database are used, the message can further include version information denoting the database version to which the time zone identifier refers.

In some embodiments in which the message includes an IANA time zone identifier, the message can include an information element(s) indicative of an IANA time zone representation. The information element can, for example, be a type 4 information element with a minimal length of 7 octets and a maximal length of 65 octets. The IANA Time Zone version can, for example, be encoded as ASCII text string. In some such example embodiments, information elements included in a message indicative of the IANA time zone and IANA time zone version can, by way of non-limiting example, be formatted as follows:

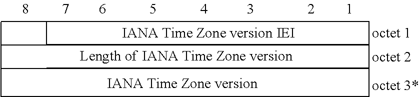

In some example embodiments in which the message that can be formatted in operation 600 includes an information element(s) IANA time zone identifier and/or IANA time zone version, the message can, for example, be a Mobility Management (MM) information message including the IANA time zone identifier. As another example, in some example embodiments in which the message that can be formatted in operation 600 includes an information element(s) IANA time zone identifier and/or IANA time zone version, the message can, for example, be an Evolved Packet Service (EPS) Mobility Management (EMM) information message including the IANA time zone identifier.

In some example embodiments, location information that can be included in a message that can be formatted in operation 600 can additionally or alternatively include a name and/or coordinates representative of a location in the time zone, such as a position of the serving network access point and/or a position of a city or other location within the time zone. In such example embodiments, the name/coordinates can be usable by the wireless communication device 102 to derive the time zone by determining the time zone including the location represented by the name/coordinates.

Operation 610 can include the network entity sending the message formatted in operation 600 to the wireless communication device 102. In some example embodiments, operation 610 can include sending the message such that it is addressed to the wireless communication device 102. Additionally or alternatively, operation 610 can include broadcasting the message (e.g., within a cell or portion thereof that can be associated with the network access point 104) such that it can be received by the wireless communication device 102.

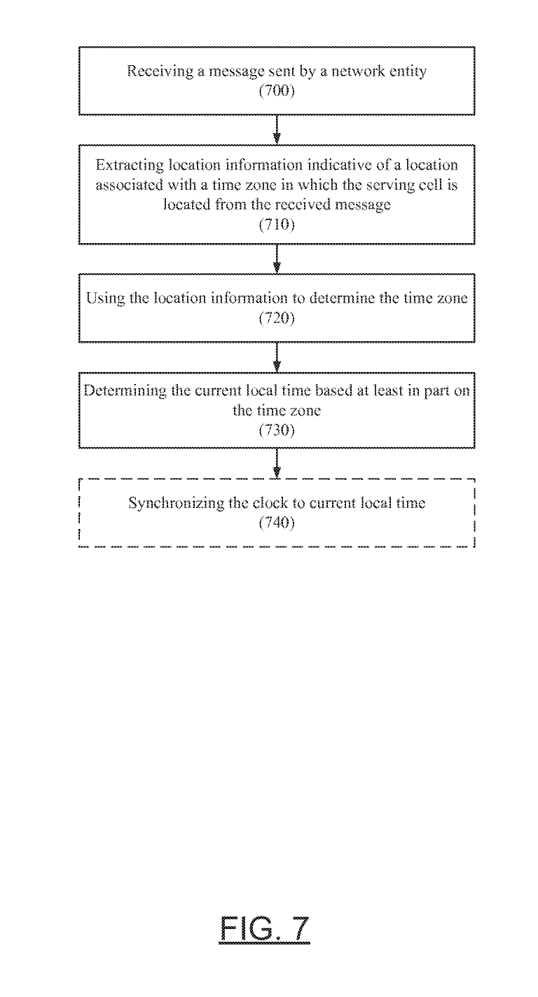

FIG. 7 illustrates a flowchart according to an example method for obtaining time zone information and determining current local time at a wireless communication device in accordance with some example embodiments. In this regard, FIG. 7 illustrates a method that can be the wireless communication device 102 in accordance with some example embodiments. One or more of processor 202, transceiver 204, memory 206, processing circuitry 310, processor 312, memory 314, transceiver 316, or local time determination module 318 can, for example, provide means for performing one or more of the operations illustrated in and described with respect to FIG. 7.

Operation 700 can include the wireless communication device 102 receiving a message sent by a network entity, such as network access point 104, location server 108, and/or other network entity. In this regard, operation 700 can include receiving a message that can be sent by a network entity attendant to performance of operation 610 as described above.

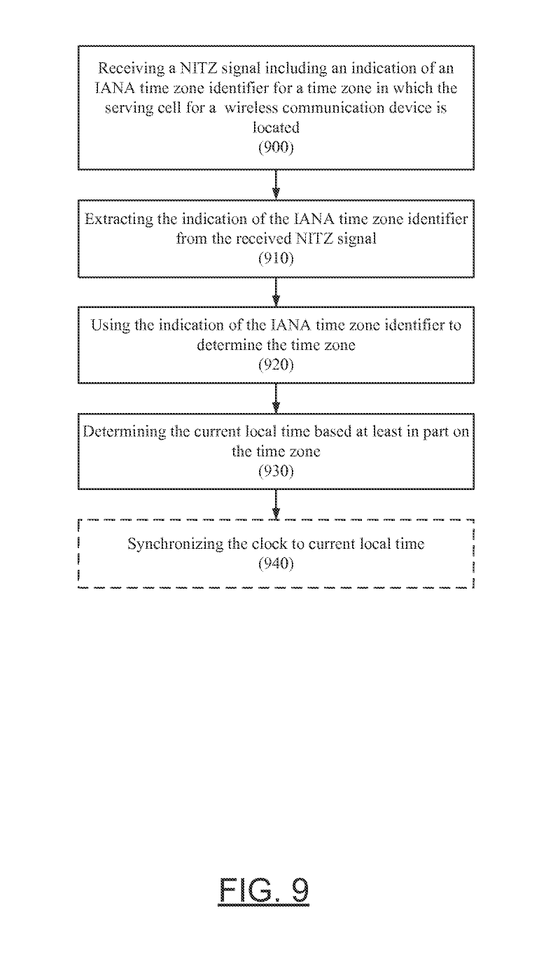

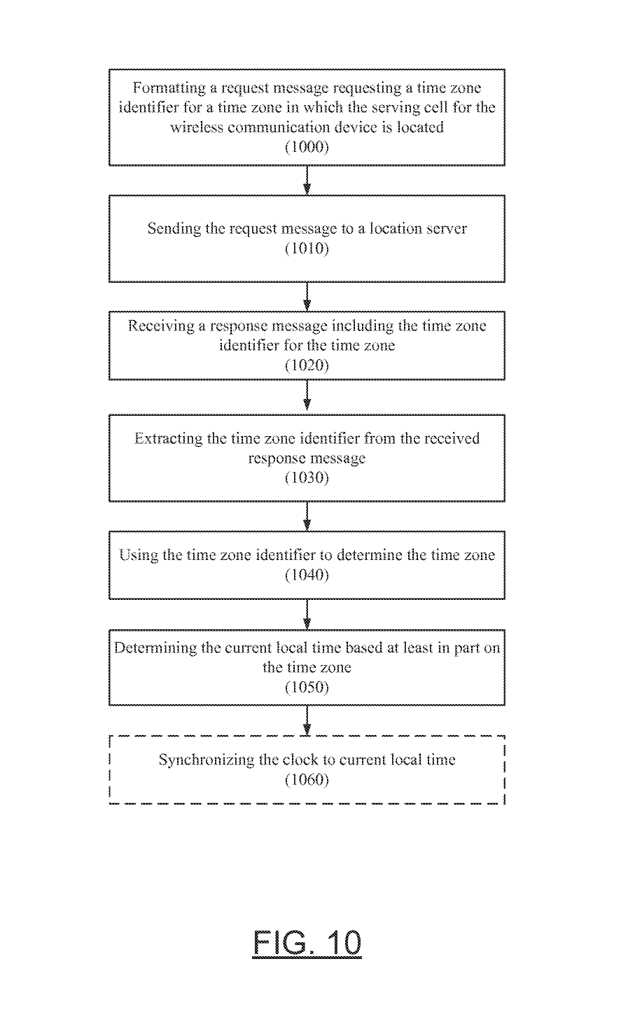

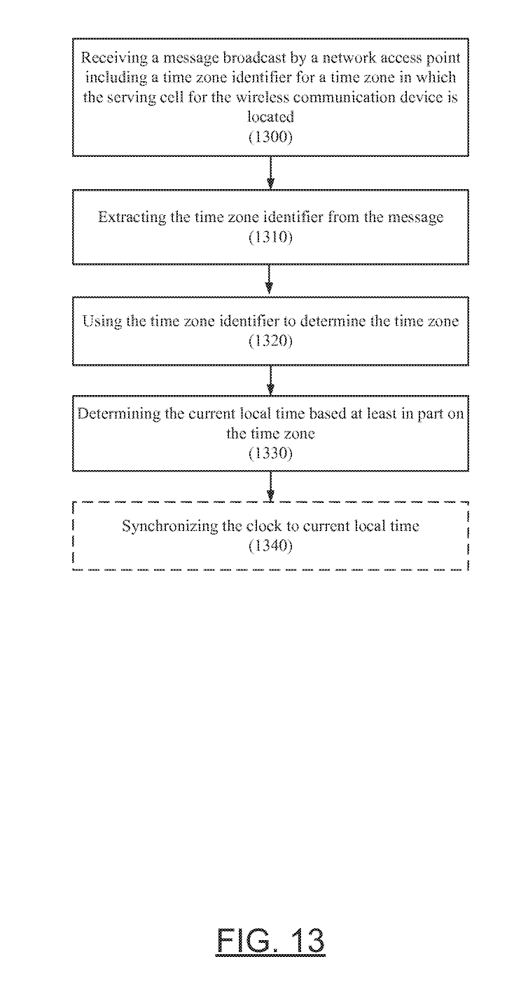

In some example embodiments, such as that illustrated in and described with respect to FIG. 9, the message that can be received in operation 700 can be a NITZ signal. As another example, in some example embodiments, such as that illustrated in and described with respect to FIG. 10, the message that can be received in operation 700 can be sent by the location server 108 in response to a request message that can sent by the wireless communication device 102 in accordance with some example embodiments. As still a further example, in some example embodiments, such as that illustrated in and described with respect to FIG. 13, the message that can be received in operation 700 can be a broadcast message that can be broadcast by the network access point 104 of some example embodiments.

The message that can be received in operation 700 can include location information indicative of a location associated with at time zone in which a serving cell for the wireless communication device 102 (e.g., a time zone in which the network access point 104) is located. For example, the message can include any of the location information described with respect to operation 600, such as an indication of an IANA time zone identifier and/or other time zone identifier, a name and/or coordinates for a location within the time zone, and/or other time zone information that can be used to identify the time zone.

Operation 710 can include the wireless communication device 102 extracting the location information from the received message. In some example embodiments, operation 710 can further include extracting an indication of whether DST is in effect from the received signal.

Operation 720 can include the wireless communication device 102 using the extracted location information to determine the time zone the time zone in which it is being operated (e.g., the time zone in which the serving cell is located). Determination of the time zone in operation 720 can include determination of a definition and/or other rules for the time zone, including information, such as a UTC offset, DST transition dates, and/or other definitions and/or rules that can be used to determine a current local time within the time zone.

In some example embodiments in which the extracted location information includes a time zone identifier, such as an indication of an IANA time zone identifier, the wireless communication device 102 can determine the time zone from the time zone identifier, such as by referencing an IANA time zone database and/or other time zone database in accordance with a standardized naming convention for time zones that can be used by the time zone identifier. The referenced database can be maintained locally on the wireless communication device 102 and/or can be maintained on a remote entity that can be accessed by the wireless communication device 102 via a network. The rules and/or definitions for the time zone can, for example, be obtained from referencing such a database.

In some example embodiments in which the extracted location information includes a name/coordinates for a location within the time zone, operation 720 can include the wireless communication device 102 using the name/coordinate information to determine the time zone including the location represented by the name/coordinates, such as by referencing the IANA time zone database.

In some example embodiments, the wireless communication device 102 can be configured to assume that the time zone determined in operation 720 applies to the tracking area of the current serving cell. For example, in some embodiments in which the received message includes an IANA time zone identifier, the wireless communication device 102 can be configured to assume that the identified IANA time zone applies to all cells within the tracking area of the current serving cell. The wireless communication device 102 of some example embodiments can be additionally or alternatively configured to assume that the determined time zone applies to a tracking area list that may be available to the wireless communication device 102 of some example embodiments.

Operation 730 can include the wireless communication device 102 determining the current local time based at least in part on the time zone determined in operation 720. For example, the wireless communication device 102 can use a definition and/or rules associated with the time zone to determine the current local time. In some embodiments in which the received message includes an indication of whether DST is in effect, operation 730 can include using the indication of whether DST is in effect to determine the current local time.

The method can optionally further include operation 740, which can include the wireless communication device 102 synchronizing a clock that can be maintained by the wireless communication device 102 to the current local time. The clock can, for example, be a clock that can be used to provide time information to time-dependent applications, such as calendar applications.

FIG. 8 illustrates a flowchart according to another example method for providing time zone information to a wireless communication device in accordance with some example embodiments. In this regard, FIG. 8 illustrates a method that can be performed by a network entity, such as the network access point 104, location server 108, and/or other network entity in accordance with some example embodiments of the method illustrated in and described with respect to FIG. 6 in which a NITZ signal can be used to convey an indication of an IANA time zone identifier to a wireless communication device. One or more of processor 402, communication interface 404, memory 406, processing circuitry 510, processor 512, memory 514, communication interface 516, or time zone information provisioning module 518 can, for example, provide means for performing one or more of the operations illustrated in and described with respect to FIG. 8.

Operation 800 can include a network entity formatting a NITZ signal including an indication of an IANA time zone identifier for a time zone in which the serving cell for the wireless communication device 102 is located. In this regard, operation 800 can, for example, correspond to an embodiment of operation 600.

Operation 810 can include the network entity sending the NITZ signal so that it is receivable by the wireless communication device 102. In this regard, operation 810 can, for example, correspond to an embodiment of operation 610.

FIG. 9 illustrates a flowchart according to another example method for obtaining time zone information and determining current local time at a wireless communication device in accordance with some example embodiments. In this regard, FIG. 9 illustrates a method that can be the wireless communication device 102 in accordance with some example embodiments of the method illustrated in and described with respect to FIG. 7 in which a NITZ signal including an indication of an IANA time zone identifier can be received by the wireless communication device 102. One or more of processor 202, transceiver 204, memory 206, processing circuitry 310, processor 312, memory 314, transceiver 316, or local time determination module 318 can, for example, provide means for performing one or more of the operations illustrated in and described with respect to FIG. 9.

Operation 900 can include the wireless communication device 102 receiving a NITZ signal including an indication of an IANA time zone identifier for a time zone in which the serving cell for a wireless communication device 102 is located. In this regard, operation 900 can correspond to an embodiment of operation 700. Operation 910 can include the wireless communication device 102 extracting the indication of the IANA time zone identifier from the received NITZ signal. In this regard, operation 910 can correspond to an embodiment of operation 710.

Operation 920 can include the wireless communication device 102 using the indication of the IANA time zone identifier to determine the time zone in which it is being operated (e.g., the time zone in which the serving cell is located). In this regard, operation 920 can correspond to an embodiment of operation 720. Operation 930 can include the wireless communication device 102 determining the current local time based at least in part on the time zone determined in operation 920. In this regard, operation 930 can correspond to an embodiment of operation 730.

The method can optionally further include operation 940, which can include the wireless communication device 102 synchronizing a clock that can be maintained by the wireless communication device 102 to the current local time. In this regard, operation 940 can correspond to an embodiment of operation 740.

In some example embodiments, the wireless communication device 102 can be configured to implement a device-initiated procedure for obtaining time zone information by requesting time zone information from the location server 108. For example, the local time determination module 318 of some example embodiments can be configured to format a request message requesting a time zone identifier for a time zone in which a serving cell for the wireless communication device 102 is located. The wireless communication device 102 of such example embodiments can be configured to send the formatted request message to the location server 108. The location server 108 of some such example embodiments can receive the request message and, in response to the request message, can determine the time zone identifier for the time zone in which the serving cell is located. The time zone identifier can include any identifier uniquely identifying the time zone that is understandable by the wireless communication device 102, such as, by way of non-limiting example, an IANA time zone identifier for the time zone.

The request message of some such example embodiments can include a cell identity. In some embodiments, the cell identity can, for example, identify the cell serving the wireless communication device. Thus, by way of non-limiting example, the cell identity can comprise a Global System for Mobile Communications (GSM) cell ID (CID), a physical cell ID (PCI), and/or any other identifier that can be used to identify a cell in a wireless communication network. Additionally or alternatively, in some example embodiments, a cell identity that can be included in a request message can identify a set of cells including the serving cell for the wireless communication device 102. Thus, for example, the cell identity can comprise a location area code, tracking area identifier, and/or other identifier that can be used to identify a group of cells in a wireless communication network.

The time zone information provisioning module 518 that can be associated with the location server 108 of some example embodiments can be configured to use a cell identity included in a request message that can be sent by the wireless communication device 102 to identify a time zone identifier associated with the cell identity. For example, the location server 108 can be configured to maintain and/or to otherwise access, such as via the network 106, a mapping (e.g., a table, database, or other data structure) defining preconfigured associations between cell identities and time zone identifiers. In this regard, a cell identity can be defined through a preconfigured association as being associated with a time zone identifier for a time zone in which a cell(s) referenced by the cell identity is located. Accordingly, the time zone information provisioning module 518 can be configured in some example embodiments to determine the time zone identifier for the time zone in which the serving cell for the wireless communication device 102 is located by looking up the time zone identifier associated with a cell identity corresponding to the serving cell that can be included in a received request message.

In some example embodiments in which the location server 108 comprises a SUPL server or the like, a request message and response message that can be exchanged between the wireless communication device 102 and location server 108 can comprise messages exchanged in accordance with SUPL protocol and/or other present or future Open Mobile Alliance (OMA) standard. For example, some example embodiments provide for extension of a SUPL location request to request a time zone identifier for a time zone in which a serving cell is located and for extension of a response to such a SUPL location request to include the time zone identifier. Additionally or alternatively, some example embodiments provide for dedicated SUPL signaling for requesting and providing time zone information. In this regard, some example embodiments provide a dedicated SUPL time zone identifier request and corresponding SUPL time zone identifier response. Such dedicated signaling may be beneficial, for example, in instances in which a user of the wireless communication device 102 has blocked or otherwise limited SUPL location requests due to privacy concerns.

In some example embodiments, such as in some embodiments in which the location server 108 comprises a SUPL server or the like, request and response messages that can be exchanged between the location server 108 and wireless communication device 102 in accordance with various example embodiments can comprise user plane messages (e.g., a user plane request message and/or a user plane response message). Additionally or alternatively in some example embodiments, such as in some embodiments in which the location server 108 comprises a server maintained by a carrier network, request and response messages that can be exchanged between the location server 108 and wireless communication device 102 in accordance with various example embodiments can comprise control plane messages (e.g., a control plane request message and/or a control plane response message).

FIG. 10 illustrates a flowchart according to a further example method for obtaining time zone information and determining current local time at a wireless communication device in accordance with some example embodiments. In this regard, FIG. 10 illustrates a method that can be the wireless communication device 102 in accordance with some example embodiments of the method illustrated in and described with respect to FIG. 7 in which the wireless communication device 102 can be configured to use a device-initiated procedure to request time zone information. One or more of processor 202, transceiver 204, memory 206, processing circuitry 310, processor 312, memory 314, transceiver 316, or local time determination module 318 can, for example, provide means for performing one or more of the operations illustrated in and described with respect to FIG. 10.

Operation 1000 can include the wireless communication device 102 formatting a request message requesting a time zone identifier for a time zone in which the serving cell for the wireless communication device is located. In some example embodiments, such as some embodiments in which the location server 108 is embodied as a SUPL server, the request message can be SUPL request. Operation 1010 can include the wireless communication device 102 sending the request message that can be formatted in operation 1010 to the location server 108.

In some example embodiments, the wireless communication device 102 can be configured to determine to perform operations 1000 and 1010 in response to a predefined event or condition. For example, in some embodiments, if the wireless communication device 102 has knowledge or otherwise believes that a DST setting is to change (e.g., DST is to go into effect or DST period is to end) on a particular date, the wireless communication device 102 can initiate a procedure to obtain a time zone identifier by sending a request message to location server 108.

In some embodiments, wireless communication device 102 can send a request message (e.g., attendant to performance of operation 1010) to location server 108 even when connected to a non-cellular network, such as via a network access point other than network access point 104. For example, in some example embodiments, wireless communication device 102 can connect to network 106 via a wireless local area network (WLAN) access point, such as for purposes of offloading traffic from a cellular network or when cellular network access is not available, and can send a request message to the location server 108 via the WLAN network. A request message sent via a non-cellular network access point can, for example, include a cell identity for a cell on which the wireless communication device 102 was last camped (e.g., a last serving cell for the wireless communication device 102) before switching to the non-cellular network access point and/or can include a current serving cell identity in some instances in which the wireless communication device 102 can support multiple concurrent network connections.

Operation 1020 can include the wireless communication device 102 receiving a response message in response to the request message that can be sent in operation 1010. In some example embodiments, such as some embodiments in which the location server 108 is embodied as a SUPL server, the response message can be a SUPL response message. The response message can include the time zone identifier for the time zone in which the serving cell for a wireless communication device 102 is located. In this regard, operation 1020 can correspond to an embodiment of operation 700. Operation 1030 can include the wireless communication device 102 extracting the time zone identifier from the received response message. In this regard, operation 1030 can correspond to an embodiment of operation 710.

Operation 1040 can include the wireless communication device 102 using the extracted time zone identifier to determine the time zone in which it is being operated (e.g., the time zone in which the serving cell is located). In this regard, operation 1040 can correspond to an embodiment of operation 720. Operation 1050 can include the wireless communication device 102 determining the current local time based at least in part on the time zone determined in operation 1040. In this regard, operation 1050 can correspond to an embodiment of operation 730.

The method can optionally further include operation 1060, which can include the wireless communication device 102 synchronizing a clock that can be maintained by the wireless communication device 102 to the current local time. In this regard, operation 1060 can correspond to an embodiment of operation 740.

FIG. 11 illustrates a flowchart according to an example method for providing time zone information to a wireless communication device in response to a request in accordance with some example embodiments. In this regard, FIG. 11 illustrates a method that can be performed by the location server 108 in accordance with some example embodiments of the method illustrated in and described with respect to FIG. 6 in which a device-initiated procedure can be used by the wireless communication device 102 to request time zone information. One or more of processor 402, communication interface 404, memory 406, processing circuitry 510, processor 512, memory 514, communication interface 516, or time zone information provisioning module 518 can, for example, provide means for performing one or more of the operations illustrated in and described with respect to FIG. 11.

Operation 1100 can include the location server 108 receiving a request message requesting a time zone identifier for a time zone in which a serving cell for the wireless communication device 102 is located. The received message can, for example, be the message that can be sent by the wireless communication device 102 attendant to performance of operation 1010. In some example embodiments, such as some embodiments in which the location server 108 is embodied as a SUPL server, the request message can be a SUPL request.

Operation 1110 can include the location server 108 determining the time zone identifier for the time zone in which the serving cell for the wireless communication device 102 is located. For example, operation 1110 can include the location server 108 determining the time zone identifier for the time zone in which the serving cell for the wireless communication device 102 is located by looking up a cell identity included in the received request message in a database or other structure defining mappings between cell identifiers and time zones to determine the time zone identifier associated with the cell identity.

Operation 1120 can include the location server 108 sending a response message including the time zone identifier determined in operation 1110 to the wireless communication device 102 in response to the received request message. In this regard, operation 1120 can, for example, correspond to an embodiment of operation 610. The response message that can be sent in operation 1120 can, for example, correspond to the response message that can be received by the wireless communication device 102 in operation 1020 as described above. In some example embodiments, such as some embodiments in which the location server 108 is embodied as a SUPL server, the response message can be a SUPL response.

Some example embodiments provide for the broadcast of time zone information by a network access point, such as the network access point 104, to wireless communication devices served by the network access point. In this regard, some example embodiments can include time zone information in a message that can be broadcast within a cell or portion thereof that can be served by the network access point 104 of some example embodiments. By way of example, the network access point 104 of such example embodiments can be configured to format a broadcast message including a time zone identifier for a time zone in which a cell associated with the network access point 104 is located. The time zone in which the serving cell is located can accordingly correspond to the time zone in which the network access point 104 is located.

The broadcast message can comprise any message that can be broadcast by a network access point 104 or other network access point. In some example embodiments, the broadcast message can comprise a dedicated message for conveying time zone information. Additionally or alternatively, in some example embodiments, a broadcast message, such as a system information message, can be extended to include the time zone identifier.

The time zone identifier included in the broadcast message of such example embodiments can include any identifier uniquely identifying the time zone that is understandable by the wireless communication device 102. In some example embodiments, the time zone identifier can comprise an identifier specified for a time zone in accordance with a standardized naming convention for time zones. For example, in some example embodiments, the time zone identifier can include an indication of an IANA time zone identifier for the time zone. It will be appreciated, however, that other time zone naming conventions that presently exist or that may be developed in the future can be used in addition to or in lieu of IANA time zone identifiers in accordance with some example embodiments. In some example embodiments in which the time zone identifier is an identifier from a standardized database or set of time zone identifiers, such as in embodiments in which IANA time zone identifiers from an IANA time zone database are used, the broadcast message can further include version information denoting the database version to which the time zone identifier refers.

The network access point 104 can be further configured to broadcast the broadcast message so that it is receivable by one or more wireless communication devices 102 that can be served by the network access point 104. The wireless communication device 102 can accordingly be configured in such embodiments to receive the broadcast message and to extract the time zone identifier from the broadcast message and use the extracted time zone identifier to determine the time zone in which it is being operated (e.g., the time zone in which the serving cell is located) and to derive a current local time.

FIG. 12 illustrates a flowchart according to an example method for broadcasting time zone information in accordance with some example embodiments. In this regard, FIG. 12 illustrates a method that can be performed by the network access point 104 in accordance with some example embodiments of the method illustrated in and described with respect to FIG. 6 in which time zone information can be included in a broadcast message. One or more of processor 402, communication interface 404, memory 406, processing circuitry 510, processor 512, memory 514, communication interface 516, or time zone information provisioning module 518 can, for example, provide means for performing one or more of the operations illustrated in and described with respect to FIG. 12.

Operation 1200 can include the network access point 104 formatting a broadcast message including a time zone identifier for a time zone in which the cell (e.g., the cell with which the network access point 104 can be associated) is located. The time zone identifier can, by way of non-limiting example, include an indication of an IANA time zone identifier. The broadcast message can comprise any message that can be broadcast by the network access point 104. In some example embodiments, the broadcast message can comprise a dedicated message for conveying time zone information. Additionally or alternatively, in some example embodiments, a broadcast message, such as a system information message, can be extended to include the time zone identifier. Operation 1200 can, for example, correspond to an embodiment of operation 600.

Operation 1210 can include the network access point 104 broadcasting the broadcast message that can be formatted in operation 1200 so that it is receivable by wireless communication devices served by the cell. In this regard, operation 1210 can, for example, correspond to an embodiment of operation 610.

FIG. 13 illustrates a flowchart according to a further example method for obtaining time zone information and determining current local time at a wireless communication device in accordance with some example embodiments. In this regard, FIG. 13 illustrates a method that can be the wireless communication device 102 in accordance with some example embodiments of the method illustrated in and described with respect to FIG. 7 in which time zone information can be included in a broadcast message that can be broadcast by network access point 104. One or more of processor 202, transceiver 204, memory 206, processing circuitry 310, processor 312, memory 314, transceiver 316, or local time determination module 318 can, for example, provide means for performing one or more of the operations illustrated in and described with respect to FIG. 13.

Operation 1300 can include the wireless communication device 102 receiving a message broadcast by a network access point including a time zone identifier for a time zone in which the serving cell for the wireless communication device is located. The time zone identifier can, for example, include an indication of an IANA time zone identifier. In this regard, operation 1300 can correspond to an embodiment of operation 700.

Operation 1310 can include the wireless communication device 102 extracting the time zone identifier from the received broadcast message. In this regard, operation 1310 can correspond to an embodiment of operation 710.

Operation 1320 can include the wireless communication device 102 using the extracted time zone identifier to determine the time zone in which it is being operated (e.g., the time zone in which the serving cell is located). In this regard, operation 1320 can correspond to an embodiment of operation 720. Operation 1330 can include the wireless communication device 102 determining the current local time based at least in part on the time zone determined in operation 1320. In this regard, operation 1330 can correspond to an embodiment of operation 730.

The method can optionally further include operation 1340, which can include the wireless communication device 102 synchronizing a clock that can be maintained by the wireless communication device 102 to the current local time. In this regard, operation 1340 can correspond to an embodiment of operation 740.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

In the foregoing detailed description, reference was made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Further, the foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. The description of and examples disclosed with respect to the embodiments presented in the foregoing description are provided solely to add context and aid in the understanding of the described embodiments. The description is not intended to be exhaustive or to limit the described embodiments to the precise forms disclosed. It will be apparent to one of ordinary skill in the art that many modifications, alternative applications, and variations are possible in view of the above teachings. In this regard, one of ordinary skill in the art will readily appreciate that the described embodiments may be practiced without some or all of these specific details. Further, in some instances, well known process steps have not been described in detail in order to avoid unnecessarily obscuring the described embodiments.

What is claimed is:

1. A method for determining current local time for a wireless communication device based on network-provided time zone information, the method comprising the wireless communication device:
receiving a message sent by a network entity, the message comprising an indication of an Internet Assigned Numbers Authority (IANA) time zone identifier for a time zone in which a serving cell for the wireless communication device is located;
extracting the indication of the IANA time zone identifier from the message;
using the indication of the IANA time zone identifier to determine the time zone; and
determining a current local time based at least in part on the time zone.

2. The method of claim 1, further comprising the wireless communication device synchronizing a clock maintained by the wireless communication device to the current local time.

3. The method of claim 1, wherein the message is a Network Identity and Time Zone (NITZ) message comprising the indication of the IANA time zone identifier.

4. The method of claim 1, wherein the message is a message broadcast by a network access point associated with the serving cell.

5. The method of claim 1, further comprising the wireless communication device:
formatting a request message requesting the IANA time zone identifier for the time zone in which the serving cell for the wireless communication device is located; and
sending the request message to a location server;
wherein receiving the message sent by the network entity comprises receiving a message sent by the location server in response to the request message.

6. The method of claim 5, wherein the location server comprises a Secure User Plane Location (SUPL) server.

7. The method of claim 5, wherein sending the request message to the location server comprises sending a control plane request to the location server.

8. The method of claim 5, wherein formatting the request message comprises formatting a request message including a cell identity identifying one or more of the serving cell for the wireless communication device or a set of cells including the serving cell for the wireless communication device.

9. The method of claim 1, wherein the message further comprises an indication of whether daylight savings time is in effect in the time zone, and wherein determining the current local time comprises determining the current local time further based on the indication of whether daylight savings time is in effect.

10. A wireless communication device comprising:
a transceiver configured to transmit data to and receive data from a wireless network; and
processing circuitry coupled to the transceiver, the processing circuitry configured to control the wireless communication device to at least:
receive a message sent by a network entity, the message comprising location information indicative of a location associated with a time zone in which a serving cell for the wireless communication device is located;
extract the location information from the message;
use the location information to determine the time zone; and
determine a current local time based at least in part on the time zone.

11. The wireless communication device of claim 10, wherein the location information comprises an indication of an Internet Assigned Numbers Authority (IANA) time zone identifier for the time zone.

12. The wireless communication device of claim 10, wherein the location information comprises coordinates representative of a location in the time zone, and wherein the processing circuitry is configured to control the wireless communication device to use the location information to determine the time zone at least in part by controlling the wireless communication device to use the coordinates to determine a time zone including the location represented by the coordinates.

13. The wireless communication device of claim 10, wherein the message is a Network Identity and Time Zone (NITZ) message comprising the location information.

14. The wireless communication device of claim 10, wherein the message is a message broadcast by a network access point associated with the serving cell.

15. The wireless communication device of claim 10, wherein the location information comprises a time zone identifier for the time zone, and wherein the processing circuitry is further configured to control the wireless communication device to:
format a request message requesting the time zone identifier for the time zone in which the serving cell for the wireless communication device is located;
send the request message to a location server; and
receive the message sent by the network entity by controlling the wireless communication device to receive a message comprising an indication of the time zone identifier sent by the location server in response to the request message.

16. A method for providing time zone information to a wireless communication device, the method comprising a network entity:
formatting a message including a time zone identifier indicative of a time zone in which a serving cell for the wireless communication device is located; and
sending the message to the wireless communication device.

17. The method of claim 16, wherein the message is a Network Identity and Time Zone (NITZ) message comprising the time zone identifier.

18. The method of claim 16, wherein the network entity comprises a network access point associated with the serving cell, and wherein sending the message comprises broadcasting the message.

19. The method of claim 16, wherein the network entity comprises a location server, the method further comprising the location server:
receiving a request message originated by the wireless communication device, the request message requesting the time zone identifier indicative of the time zone in which the serving cell for the wireless communication device is located;
determining the time zone identifier for the time zone; and
sending the message including the time zone identifier to the wireless communication device in response to the request message.

20. The method of claim 16, wherein the time zone identifier comprises an indication of an Internet Assigned Numbers Authority (IANA) time zone identifier for the time zone.
